(19) United States
(12) Patent Application Publication
(10) Pub. No.: US 2025/0246169 A1
(43) Pub. Date: Jul. 31, 2025

(54) REED

(71) Applicant: YAMAHA CORPORATION, Hamamatsu-shi (JP)

(72) Inventor: Akiko SATO, Hamamatsu-shi (JP)

(21) Appl. No.: 19/018,285

(22) Filed: Jan. 13, 2025

(30) Foreign Application Priority Data
Jan. 26, 2024 (JP) 2024-010019

(51) Int. Cl. G10D 9/035

(52) U.S. Cl. CPC G10D 9/035

(57) ABSTRACT

A reed for a mouthpiece of a wind instrument includes a base part and a vamp. The base part extends in a first direction and includes a first surface and a second surface opposite to the first surface. At least one of the first surface or the second surface includes at least one groove extending along a second direction that intersects the first direction. The vamp extends from the base part along the first direction.

### CROSS-REFERENCE TO RELATED APPLICATIONS

The present application claims priority under 35 U.S.C. § 119 to Japanese Patent Application No. 2024-010019, filed Jan. 26, 2024. The contents of this application are incorporated herein by reference in their entirety.

### BACKGROUND

The present disclosure relates to a reed.

In general, a reed that causes vibrations for sound production is attached to a mouthpiece of a wind instrument, such as a saxophone or a clarinet. In recent years, besides conventional reeds made of natural materials, such as Arundo donax, resin reeds have been put to practical use. Because a specific gravity of a resin is larger than a specific gravity of Arundo donax in a resin reed, a resin having the lowest possible specific gravity is preferable. The resin reed is often designed to be thinner than a reed made of Arundo donax in order to decrease a mass of the reed.

U.S. Pat. No. 7,902,443B2 discloses thinning a heel part of a reed. U.S. Pat. No. 8,766,072B2 discloses forming a groove extending along a longitudinal direction of a heel on a heel part of a reed.

With the reed described in U.S. Pat. No. 7,902,443B2, in the case of using general mouthpiece and ligature, it is difficult to stably attach the reed to the mouthpiece because the heel part is too thin depending on a combination of the mouthpiece and the ligature.

With the reed described in U.S. Pat. No. 8,766,072B2, even though the mass of the reed becomes less than an embodiment where a groove is omitted, there is no effect on bending of the reed, thus failing to contribute to sound-producing property.

An object of the present disclosure is to provide a reed that is excellent in playability and sound-producing property and is stably attachable.

### SUMMARY

One aspect is a reed for a mouthpiece of a wind instrument. The reed includes a base part and a vamp. The base part extends in a first direction and includes a first surface and a second surface opposite to the first surface. At least one of the first surface or the second surface includes at least one groove extending along a second direction that intersects the first direction. The vamp extends from the base part along the first direction.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a sectional view of a mouthpiece with a reed of an embodiment attached to the mouthpiece;

FIG. 2 is a perspective view of a reed in an embodiment;

FIG. 3 is a plan view of a reed in an embodiment;

FIG. 4 is a side view of a reed in an embodiment;

FIG. 5 is a sectional view taken along line A-A of FIG. 3;

FIG. 6 is a plan view of a reed in Modification 1;

FIG. 7 is a plan view of a reed in Modification 2;

FIG. 8 is a plan view of a reed in Modification 3;

FIG. 9 is a plan view of a reed in Modification 4; and

FIG. 10 is a plan view of a reed in Modification 5.

### DETAILED DESCRIPTION

The present specification is applicable to a reed.

Embodiments of the present disclosure are described below with reference to the drawings. In the drawings, dimensions and reduced scales of individual components are appropriately different from those of actual ones. The following embodiments are suitable specific examples of the present disclosure. Therefore, technically preferred various limitations are imposed on these embodiments. However, the scope of the present disclosure is not limited to these embodiments unless otherwise stated as limiting the present disclosure in the following description.

### Usage State of Reed

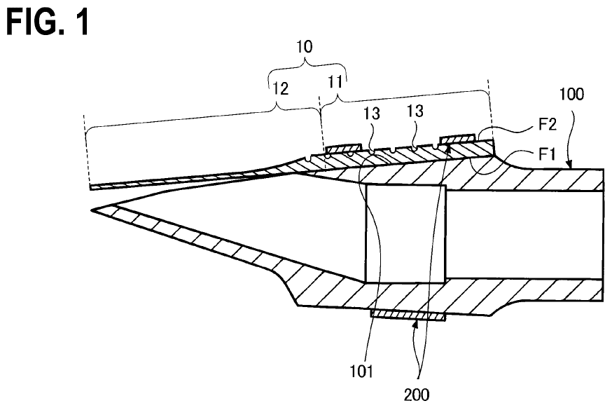

FIG. 1 is a sectional view of a mouthpiece 100 with a reed 10 of the embodiment attached to the mouthpiece 100. FIG. 1 illustrates a cross section in a state where the reed 10 is attached to the mouthpiece 100 by using a ligature 200.

The mouthpiece 100 is a structure which is attached to a body of a wind instrument, such as a saxophone or a clarinet, and which is used by a player to blow into the body. The mouthpiece 100 has an approximately cylindrical shape having a pair of openings. One of the pair of openings is attached to the body. The other of the pair of openings is an inlet into which the player blows.

A table 101 that is a flat surface for attachment of the reed 10 is disposed on an outer circumferential surface of the mouthpiece 100. The reed 10 is fixed to the mouthpiece 100 by the ligature 200 in a state where the reed 10 is in contact with the table 101 and covers the other opening with spacing interposed between them. The mouthpiece 100 and the ligature 200 are not limited to an example illustrated in FIG. 1, but these are optional, and well-known different combinations may be employed.

The reed 10 is a long thin planar member that vibrates by the player's breath blown into with the reed 10 attached to the mouthpiece 100. The reed 10 includes a base part 11 and a vamp 12.

The base part 11 is a planar part which is a part of the reed 10 and is fixed to the table 101 of the mouthpiece 100 by the ligature 200, and which is also called a heel. The base part 11 includes a first surface F1 and a second surface F2. The first surface F1 is a surface that comes into contact with the table 101. The second surface F2 is a surface opposite to the first surface F1.

The vamp 12 is a planar part which is a part of the reed 10 and extends from the base part 11 toward a tip of the reed 10, and which becomes thinner toward the tip of the reed 10. The vamp 12 vibrates by the player's breath blown into.

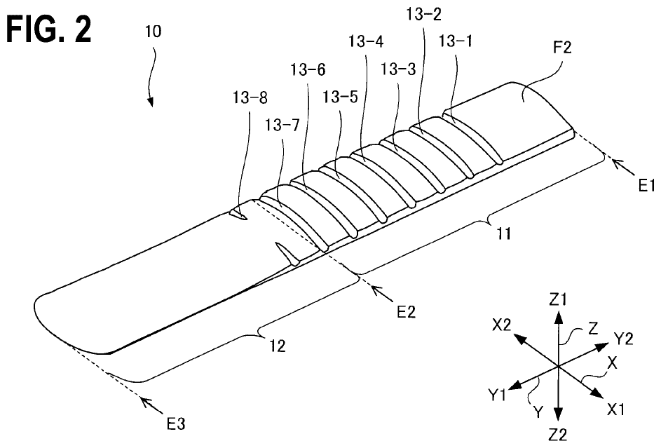

The reed 10 briefly described above includes a plurality of grooves 13. This makes it possible to provide the reed 10 that is excellent in sound-producing property and is stably attachable. The reed 10 is described below with reference to FIGS. 2 to 5.

### Reed

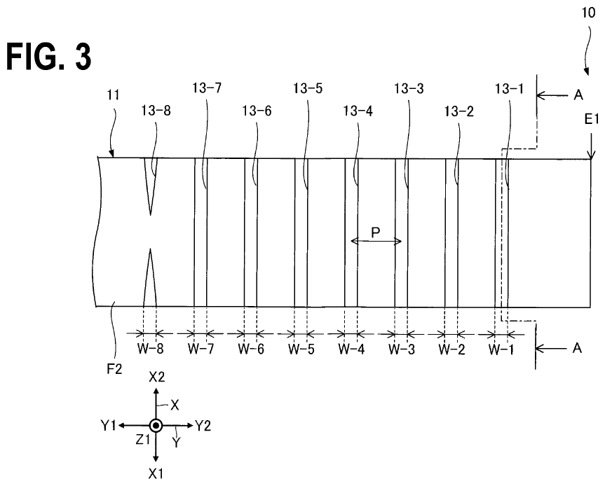

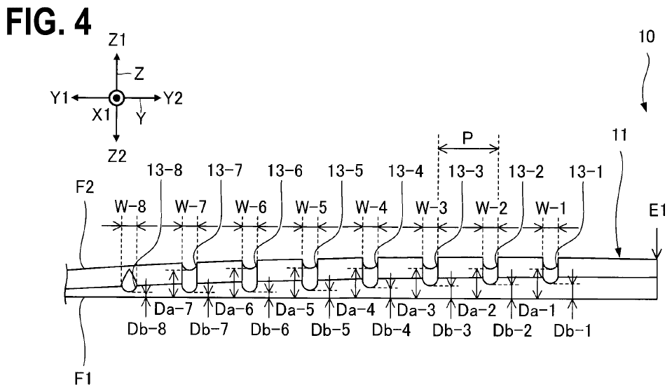

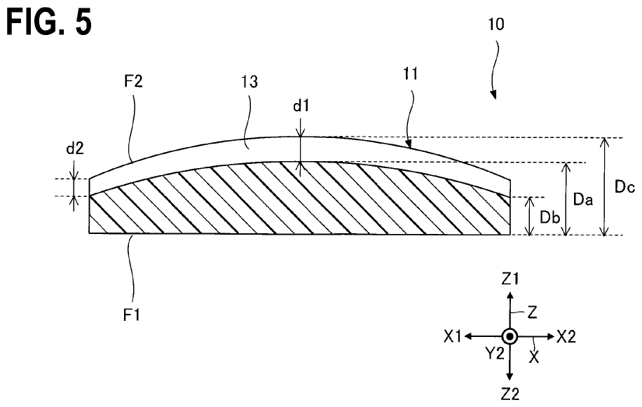

FIG. 2 is a perspective view of a reed 10 of an embodiment. FIG. 3 is a plan view of a reed in an embodiment. FIG. 4 is a side view of a reed in an embodiment. FIG. 5 is a sectional view taken along line A-A of FIG. 3.

The reed 10 is described below with reference to FIGS. 2 to 5. For the sake of convenience, the following description is made by appropriately using X-axis, Y-axis, and Z-axis that are orthogonal to one another. The X-axis is the axis along a width direction of the reed 10. The Y-axis is the axis along a longitudinal direction of the reed 10. The Z-axis is the axis along a thickness direction of the reed 10. In the following, a direction along the X-axis is X1 direction, and a direction opposite to the X1 direction is X2 direction. The X1 direction or the X2 direction is an example of “a second direction.” A direction along the Y-axis is Y1 direction, and a direction opposite to the Y1 direction is Y2 direction. The Y1 direction is an example of “a first direction.” A direction along the Z-axis is Z1 direction, and a direction opposite to the Z1 direction is Z2 direction. However, “the second direction” is not limited to a direction parallel to the X-axis, but may have a directional component along the X-axis.

As illustrated in FIG. 2, the reed 10 extends in the direction along the Y-axis, and includes a first end E1, a second end E2, and a third end E3.

The first end E1 is the end of the base part 11 in the Y2 direction. That is, the first end E1 is the end of the reed 10 in the Y2 direction. The second end E2 is the end of the base part 11 in the Y1 direction. The third end E3 is the end of the vamp 12 in the Y1 direction and is generally called a tip. That is, the third end E3 is the end of the reed 10 in the Y1 direction.

Thus, the reed 10 is divided into the base part 11 and the vamp 12 by the second end E2. The base part 11 has a shape extending in the Y1 direction from the first end E1 toward the second end E2. The vamp 12 has a shape extending from the second end E2 of the base part 11 along the Y1 direction.

Grooves 13-1 to 13-7 are disposed on the second surface F2 of the base part 11. A groove 13-8 is disposed on the second surface F2 of the vamp 12. The grooves 13-1 to 13-8 are recesses individually extending along a direction along the X-axis. The grooves 13-1 to 13-8 correspond respectively to the grooves 13 illustrated in FIG. 1. The grooves 13-1 to 13-8 are referred to as the grooves 13 in some cases without distinguishing between them. The number of the grooves 13 disposed on the base part 11 is not limited to the example illustrated in the drawing, but may be 6 or less, or alternatively, three or more.

Thus, the reed 10 can have a smaller mass than an embodiment including no groove 13 by disposing the grooves 13-1 to 13-7 on the second surface F2 of the base part 11. With this, even when the base part 11 is thick enough to use a general mouthpiece 100 and a general ligature 200, the reed 10 becomes easier to vibrate. It is therefore possible to improve playability that the player feels vibration of the whole of the reed 10. Additionally, because the at least one groove 13 extends along the X1 direction or the X2 direction intersecting the Y1 direction that is the longitudinal direction of the base part 11, it is possible to facilitate bending of the reed 10. That is, because not only the vamp 12 but also the base part 11 becomes easier to bend, the whole of the reed 10 becomes easier to bend. This facilitates to reduce a distance between the reed 10 and the mouthpiece 100, thereby facilitating sound production. From the above, it is possible to provide the reed 10 that is excellent in sound-producing property and is stably attachable.

With this embodiment, the grooves 13-1 to 13-8 are disposed on the second surface F2, whereas no groove is disposed on the first surface F1. It is thereby possible to dispose the grooves 13 on the base part 11 while improving adhesion between the mouthpiece 100 and the base part 11 of the reed 10.

Furthermore, the grooves 13-1 to 13-7 are not disposed on the vamp 12. This contributes to reducing uncomfortable feeling of the player. However, the groove 13 may be disposed on the vamp 12 if it is a portion where the player has no uncomfortable feeling, that is, the portion, except for a part of the reed 10 to be inserted into a mouth of the player during playing (generally, a part in a range of approximately 25 mm from the tip of the vamp 12).

As illustrated in FIGS. 2 to 4, the grooves 13-1 to 13-8 are arranged in this order toward the Y1 direction. Thus, the plurality of grooves 13 disposed on the base part 11 are arranged along the Y1 direction. With this, there is an advantage that it is easy to impart suitable flexibility to the reed 10. In the embodiment illustrated in FIGS. 2 to 4, the grooves 13-1 to 13-8 are evenly spaced at intervals P. The intervals P of the plurality of grooves 13 may not be equal intervals. For example, the intervals P of the plurality of grooves 13 may become smaller or larger toward the Y1 direction, however, it is preferable to become smaller.

In the embodiment illustrated in FIGS. 2 to 4, widths W-1 to W-8 of the grooves 13-1 to 13-8 in a direction along the Y-axis are equal to one another. However, the widths W-1 to W-7 respectively corresponding to the grooves 13-1 to 13-7 are a constant width, whereas the width W-8 of the groove 13-8 becomes smaller from opposite ends toward a center in a width direction of the base part 11. Here, the groove 13-8 is configured with a pair of grooves divided by the center in the width direction of the base part 11 or the vamp 12.

Thus, the grooves 13-1 to 13-8 include the groove 13-8 whose width in the direction along the Y-axis is not constant. With this, there is an advantage that it is easy to impart suitable flexibility to the reed 10. The groove 13-8 may be a single groove not divided at the center in the width direction of the base part 11 (in the direction along the X-axis) as in the case of connecting the pair of grooves, or may be a groove having a constant width (a width in a direction along the Y-axis). The widths W-1 to W-7 respectively corresponding to the grooves 13-1 to 13-7 may not be the constant width, but may, for example, become smaller or larger from the opposite ends toward the center in the width direction of the base part 11, however, it is preferable to become larger.

A cross-sectional shape of the grooves 13 is a shape whose width becomes smaller toward a bottom of each of the grooves 13. Consequently, the base part 11 can be made flexible by the grooves 13 while maintaining mechanical strength necessary for the base part 11. The cross-sectional shape of the grooves 13 is a U-shape in the embodiment illustrated in FIG. 4. The cross-sectional shape of the grooves 13 is not limited to the embodiment illustrated in FIG. 4, but may be a V-shape, etc.

The reed 10 is made of a resin composition. That is, the base part 11 and the vamp 12 are individually made of the resin composition. With this, the effect obtained by disposing the grooves 13 on the base part 11 is remarkable because the specific gravity of a resin is generally larger than the specific gravity of Arundo donax.

The resin composition constituting the reed 10 includes a resin. The resin included in the resin composition is not particularly limited. However, from the viewpoint of reducing the influence of temperature and creep resistance, it is preferable to use a resin with a high specific gravity and high elasticity. Specifically, it is preferable to use an engineering plastic, such as liquid crystal polymer. The use of the engineering plastic as the resin of the resin composition makes it possible to reduce a characteristic change with respect to a change in temperature. Additionally, the engineering plastic is not only high in specific gravity but also hard among resins. Therefore, the effect becomes significant when this resin is used. The resin composition constituting the reed 10 may include, besides the resin, an organic or inorganic filler or a fiber material. Organic or inorganic coating or painting may be applied to the surface of the reed 10. Materials constituting the reed 10 are not limited to the resin composition, but may be, for example, a natural material, such as Arundo donax, or an inorganic material, such as metal.

If the reed 10 is made of the resin composition, the mass of the reed 10 can be reduced by approximately 6% by disposing the grooves 13-1 to 13-8 than the embodiment including no groove 13. Consequently, the reed 10 is more likely to vibrate, thereby improving playability.

The reed 10 made of the resin composition is molded by, for example, injection molding. Here, the grooves 13 may be formed by a metal mold used when molding, or may be formed by machining, such as NC machining, or laser processing after the molding.

As illustrated in FIG. 4, a dimensional relationship of distances Da-1 to Da-7 between bottoms of the grooves 13-1 to 13-7 at the center in the width direction of the base part 11 and the first surface F1 is an order from large to small, that is, from the distance Da-1 to Da-7. The distances Da-1 to Da-7 correspond respectively to the grooves 13-1 to 13-7. For example, the distance Da-1 is a distance between the bottom of the groove 13-1 at the center in the width direction of the base part 11 and the first surface F1. A depth of the groove 13-8 at the center in the width direction of the base part 11 is zero in the present embodiment. In the following, each of the distances Da-1 to Da-7 is called a distance Da in some cases without distinguishing between them. The distance Da of two grooves 13 adjacent to each other among the grooves 13-1 to 13-7 may be equal to each other.

Similarly, a dimensional relationship of distances Db-1 to Db-8 between bottoms of the grooves 13-1 to 13-8 at the end in the width direction of the base part 11 and the first surface F1 is an order from large to small, that is, from the distance Db-1 to Db-8. The distances Db-1 to Db-8 correspond respectively to the grooves 13-1 to 13-8. For example, the distance Db-1 is a distance between the bottom of the groove 13-1 at the end in the width direction of the base part 11 and the first surface F1. In the following, each of the distances Db-1 to Db-8 is called a distance Db in some cases without distinguishing between them. The distance Db of two grooves 13 adjacent to each other among the grooves 13-1 to 13-8 may be equal to each other.

Thus, the distance Da or the distance Db between the bottoms of the plurality of grooves 13 and the first surface F1 decreases as the distance between each groove 13 and the vamp 12 decreases. With this, there is an advantage that it is easy to impart the suitable flexibility to the reed 10.

As illustrated in FIG. 5, the distance Db between the bottoms of the grooves 13 at the end in the width direction of the base part 11 and the first surface F1 is smaller than the distance Da between the bottoms of the grooves 13 at the center in the width direction of the base part 11 and the first surface F1. Here, the distance between the bottoms of the grooves 13 and the first surface F1 gradually decreases from the center to the end in the width direction of the base part 11. With this, there is an advantage that it is easy to impart the suitable flexibility to the reed 10. The term “suitable flexibility” of the reed 10 as used here is bending that causes the tip of the reed 10 to approach the mouthpiece 100 when holding the reed 10 between one's teeth. It is easy to produce sound if this bending of the reed 10 is easy to occur.

A thickness Dc of the base part 11 is not particularly limited, but it is preferably 2.4 mm or more. In this case, it is possible to employ many combinations of existing products as the mouthpiece 100 and the ligature 200.

The present disclosure is not limited to the foregoing embodiments, but the following various modifications can be made. These embodiments and these modifications may be suitably combined together.

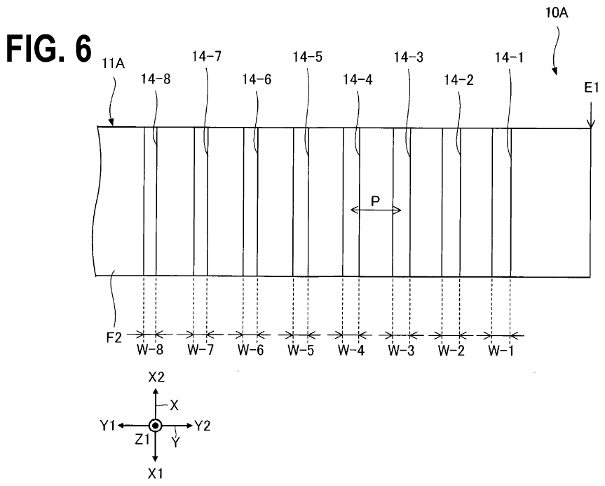

FIG. 6 is a plan view of a reed 10A of modification 1. The reed 10A is configured similarly to the reed 10 of the above embodiment, except for including a base part 11A instead of the base part 11 of the above embodiment. The base part 11A is configured similarly to the base part 11 of the above embodiment, except for disposing grooves 14-1 to 14-8 instead of the grooves 13-1 to 13-8 of the above embodiment. In the following, the grooves 14-1 to 14-8 are called the grooves 14 in some cases without distinguishing between them. The number of the grooves 14 disposed on the base part 11A is not limited to an example illustrated in the drawing, but may be seven or less, or alternatively, nine or more.

The grooves 14-1 to 14-8 are configured similarly to the grooves 13-1 to 13-8 of the above embodiment, except that they differ from one another in their width. A dimensional relationship of widths W-1 to W-8 of the grooves 14-1 to 14-8 is an order from large to small, that is, from the width W-1 to W-8 in the embodiment illustrated in FIG. 6. The widths of two grooves 14 adjacent to each other among the grooves 14-1 to 14-8 may be equal to each other.

Also with the above Modification 1, it is possible to provide the reed 10A that is excellent in sound-producing property and is stably attachable. There is also an advantage that it is easy to enhance the effect of reducing the mass of the reed 10A by the grooves 14.

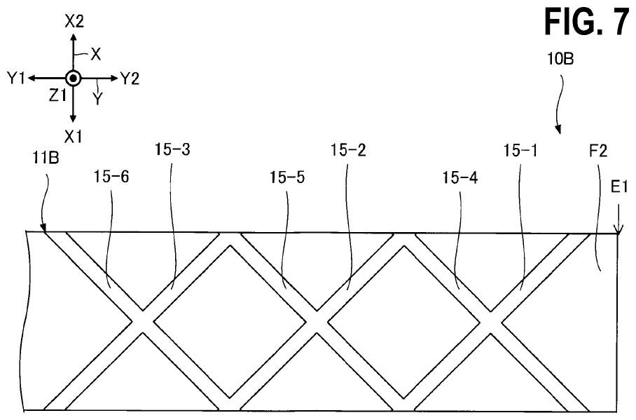

FIG. 7 is a plan view of a reed 10B of modification 2. The reed 10B is configured similarly to the reed 10 of the above embodiment, except for including a base part 11B instead of the base part 11 of the above embodiment. The base part 11B is configured similarly to the base part 11 of the above embodiment, except for disposing grooves 15-1 to 15-6 instead of the grooves 13-1 to 13-8 of the above embodiment. In the following, the grooves 15-1 to 15-6 are called the grooves 15 in some cases without distinguishing between them. The number of the grooves 15 disposed on the base part 11B is not limited to an example illustrated in the drawing, but may be five or less, or alternatively, seven or more. However, from the viewpoint of enhancing symmetry of the shape of the reed 10B, the number of the grooves 15 disposed on the base part 11B is preferably an even number.

The grooves 15-1 to 15-6 are configured similarly to the grooves 13 of the above embodiment, except that they differ from one another in extending direction. Here, the grooves 15-1 to 15-3 are arranged in this order toward the Y1 direction, and extend in a direction inclined to the X-axis. In contrast, the grooves 15-4 to 15-6 are arranged in this order and extend in a direction inclined to a side opposite to the grooves 15-1 to 15-3 with respect to the X-axis.

Here, the grooves 15-1 and 15-4 intersect each other at a center in a width direction of the base part 11B. Similarly, the grooves 15-2 and 15-5 intersect each other at the center in the width direction of the base part 11B. The grooves 15-3 and 15-6 intersect each other at the center in the width direction of the base part 11B.

The groove 15-2 connects to the groove 15-6 at an end of the groove 15-2 in X1 direction of the base part 11B, and connects to the groove 15-4 at an end of the groove 15-2 in X2-direction of the base part 11B. Similarly, the groove 15-5 connects to the groove 15-1 at an end of the groove 15-5 in the X1 direction of the base part 11B, and connects to the groove 15-3 at an end of the groove 15-5 in the X2 direction of the base part 11B.

Also with the above Modification 2, it is possible to provide the reed 10B that is excellent in sound-producing property and is stably attachable. There is also an advantage that the reed 10B is hard to break because force is less likely to be locally applied to a part of the reed 10B in a longitudinal direction. Further, there is also an advantage that the ligature is hard to slip on the reed 10B.

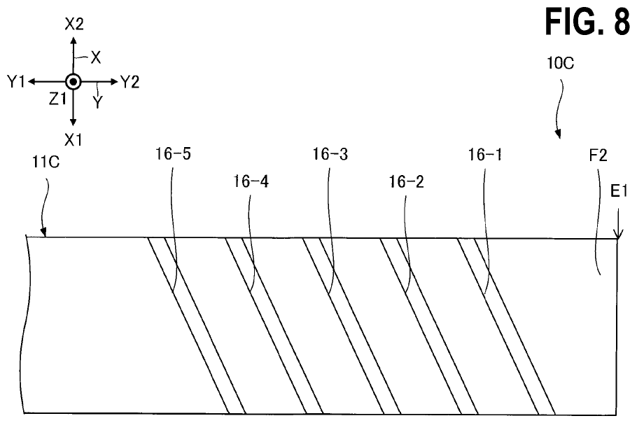

FIG. 8 is a plan view of a reed 10C of modification 3. The reed 10C is configured similarly to the reed 10 of the above embodiment, except for including a base part 11C instead of the base part 11 of the above embodiment. The base part 11C is configured similarly to the base part 11 of the above embodiment, except for disposing grooves 16-1 to 16-5 instead of the grooves 13-1 to 13-8 of the above embodiment. In the following, the grooves 16-1 to 16-5 are called the grooves 16 in some cases without distinguishing between them. The number of the grooves 16 disposed on the base part 11C is not limited to an example illustrated in the drawing, but may be four or less, or alternatively, six or more.

The grooves 16-1 to 16-5 are configured similarly to the grooves 13 of the above embodiment, except that they differ from one another in extending direction. Here, the grooves 16-1 to 16-5 are arranged in this order toward the Y1 direction, and extend in a direction inclined to the X-axis. Extending directions of the grooves 16-1 to 16-5 are parallel to one another. Here, the extending directions of the grooves 16-1 to 16-5 may not be parallel to one another.

Also with the above Modification 3, it is possible to provide the reed 10C that is excellent in sound-producing property and is stably attachable. Additionally, because the grooves 16 extend in the direction inclined to the X-axis, there is no need to strictly consider a posture of the reed 10C when machining the grooves 16, and the machining of the grooves 16 is easy.

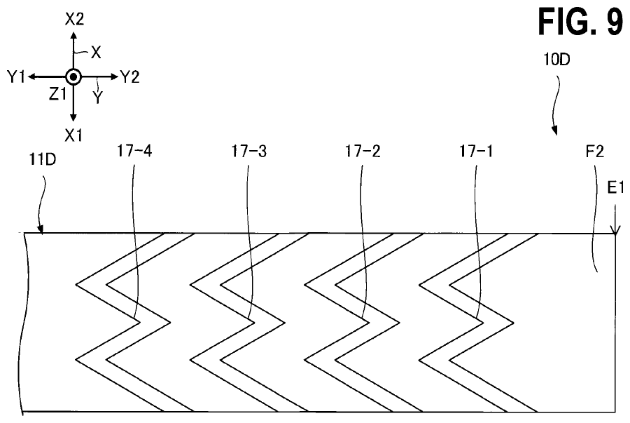

FIG. 9 is a plan view of a reed 10D of modification 4. The reed 10D is configured similarly to the reed 10 of the above embodiment, except for including a base part 11D instead of the base part 11 of the above embodiment. The base part 11D is configured similarly to the base part 11 of the above embodiment, except for disposing grooves 17-1 to 17-4 instead of the grooves 13-1 to 13-8 of the above embodiment. In the following, the grooves 17-1 to 17-4 are called the grooves 17 in some cases without distinguishing between them. The number of the grooves 17 disposed on the base part 11D is not limited to an example illustrated in the drawing, but may be three or less, or alternatively, five or more.

The grooves 17-1 to 17-4 are configured similarly to the grooves 13 of the above embodiment, except that they differ from one another in shape as viewed in a direction along the Z-axis. Here, the grooves 17-1 to 17-4 are arranged in this order toward the Y1 direction. Each of the grooves 17 has a W-shape as viewed in a direction along the Z-axis, and is made up of a plurality of parts inclined to the X-axis. The shapes of the grooves 17-1 to 17-4 as viewed from the direction along the Z-axis are identical with one another in an example illustrated in the drawing. The shapes of the grooves 17-1 to 17-4 as viewed in the direction along the Z-axis may differ from one another.

Also with the above Modification 4, it is possible to provide the reed 10D that is excellent in sound-producing property and is stably attachable. There is also an advantage that the ligature is hard to slip on the reed 10D because the grooves 17 has the shape including a bent part as viewed in the direction along the Z-axis.

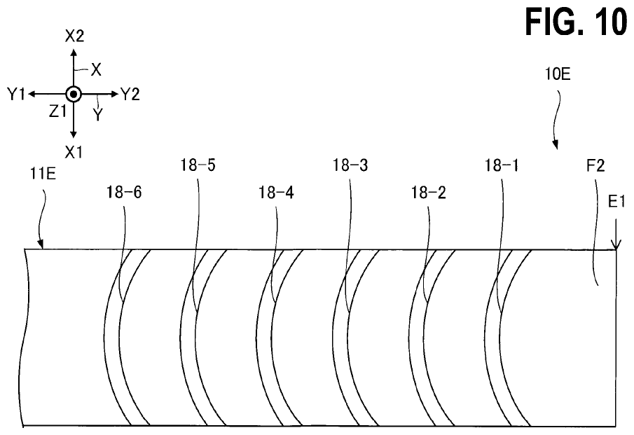

FIG. 10 is a plan view of a reed 10E of modification 5. The reed 10E is configured similarly to the reed 10 of the above embodiment, except for including a base part 11E instead of the base part 11 of the above embodiment. The base part 11E is configured similarly to the base part 11 of the above embodiment, except for disposing grooves 18-1 to 18-6 instead of the grooves 13-1 to 13-8 of the above embodiment. In the following, the grooves 18-1 to 18-6 are called the grooves 18 in some cases without distinguishing between them. The number of the grooves 18 disposed on the base part 11E is not limited to an example illustrated in the drawing, but may be five or less, or alternatively, seven or more.

The grooves 18-1 to 18-6 are configured similarly to the grooves 13 of the above embodiment, except that they differ from one another in shape as viewed in a direction along the Z-axis. Here, the grooves 18-1 to 18-6 are arranged in this order toward the Y1 direction. Each of the grooves 18 has a curved shape so as to protrude toward the Y1 direction as viewed in a direction along the Z-axis. The shapes of the grooves 18-1 to 18-6 as viewed from the direction along the Z-axis are identical with one another in an example illustrated in the drawing. The shapes of the grooves 18-1 to 18-6 as viewed in the direction along the Z-axis may differ from one another.

Also with the above Modification 5, it is possible to provide the reed 10E that is excellent in sound-producing property and is stably attachable. There is also an advantage that the ligature is hard to slip on the reed 10E because the grooves 18 has the curved shape as viewed in the direction along the Z-axis.

Although the above embodiment exemplifies an aspect in which the plurality of grooves 13 are disposed on the second surface F2, there is no intention to limit to the embodiment, but at least one groove extending in a direction having a directional component along the X-axis may be disposed on the first surface F1. In this case, the grooves 13 disposed on the second surface F2 may be omitted. Also in this case, aspects, such as the shape and number of the grooves disposed on the first surface F1, may be the same as or different from those of an aspect of the grooves 13 disposed on the second surface F2, as viewed in a thickness direction of the base part 11.

Although the above embodiment exemplifies an aspect in which the grooves 13 are disposed over the entire region in the width direction of the base part 11, there is no intention to limit to this aspect. For example, the grooves may be partly disposed at a central part or both end parts in the width direction of the base part 11. In this case, the plurality of grooves disposed on the base part 11 may differ from one another in length.

For example, the following aspects are conceived from the embodiments and modifications as exemplified above.

A first aspect that is a preferred example of the reed of the present disclosure includes the base part having the first surface and the second surface opposite to the first surface, and the vamp extending from the base part along the first direction. At least one of the first surface and the second surface include at least one groove extending along the second direction intersecting the first direction.

With the above aspect, the at least one groove is disposed on at least one of the first surface and the second surface of the base material part, and it is therefore possible to reduce the mass of the reed than an aspect including no groove. Thereby, even when the base part is thick enough to use a general mouthpiece and a general ligature, the reed becomes easier to vibrate, thereby improving playability. Additionally, because the at least one groove extends along the second direction intersecting the first direction that is the longitudinal direction of the base material part, it is possible to facilitate bending of the reed, thereby facilitating sound production. From the above, it is possible to provide the reed that is excellent in playability and sound-producing property and is stably attachable.

In a second aspect that is a preferred example of the first aspect, the first surface is the surface that comes into contact with the mouthpiece, and the at least one groove is disposed on the second surface. With this aspect, the groove can be disposed on the base part while improving adhesion between the mouthpiece and the base part of the reed.

In a third aspect that is a preferred example of the second aspect, the distance between the bottom of the at least one groove and the first surface decreases from the center toward the end in the second direction of the base material part. With this aspect, there is an advantage that it is easy to impart suitable flexibility to the reed.

In a fourth aspect that is a preferred example of the second aspect or the third aspect, the at least one groove is the plurality of grooves arranged along the first direction. With this aspect, there is an advantage that it is easy to impart suitable flexibility to the reed.

In a fifth aspect that is a preferred example of the fourth aspect, the distance between the bottoms of the plurality of grooves and the first surface decreases as a distance between the vamp and each of the plurality of grooves decreases. With this aspect, there is an advantage that it is easy to impart suitable flexibility to the reed.

In a sixth aspect that is a preferred example of any one of the first to fifth aspects, the width of the at least one groove includes a groove whose width is not constant. With this aspect, there is an advantage that it is easy to impart suitable flexibility to the reed.

In a seventh aspect that is a preferred example of any one of the first to sixth aspects, each of the base part and the vamp is made of the resin composition. With this aspect, the effect obtained by disposing the grooves on the base part is remarkable because the specific gravity of a resin is generally larger than the specific gravity of Arundo donax.

In an eighth aspect that is a preferred example of the seventh aspect, the resin composition includes an engineering plastic. With this aspect, it is possible to reduce a characteristic change with respect to a temperature change. Further, because the engineering plastic is not only high in specific gravity but also hard among resins, the effect becomes significant when this resin is used.

In a ninth aspect that is a preferred example of any one of the first to eighth aspects, the at least one groove is not disposed on the vamp. With this aspect, it is possible to reduce uncomfortable feeling of a player.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A reed for a mouthpiece of a wind instrument, the reed comprising:
a base part extending in a first direction and comprising a first surface and a second surface opposite to the first surface, at least one of the first surface or the second surface including at least one groove extending along a second direction that intersects the first direction; and
a vamp extending from the base part along the first direction.

2. The reed according to claim 1, wherein:
the first surface comes into contact with the mouthpiece in a state where the reed is attached to the mouthpiece, and
the at least one groove is disposed on a side of the second surface.

3. The reed according to claim 2, wherein a distance between a bottom of the at least one groove and the first surface decreases from a center toward an end of the base part in the second direction.

4. The reed according to claim 2, wherein the at least one groove comprises a plurality of grooves spaced along the first direction.

5. The reed according to claim 4, wherein distances between bottoms of the plurality of grooves and the first surface decrease as a distance between the vamp and each of the plurality of grooves decreases.

6. The reed according to claim 1, wherein the at least one groove comprises a groove whose width is not constant.

7. The reed according to claim 1, wherein each of the base part and the vamp is made of a resin composition.

8. The reed according to claim 7, wherein the resin composition comprises an engineering plastic.

9. The reed according to claim 1, wherein the at least one groove is not disposed on a side of the vamp.
